(19) United States
(12) Patent Application Publication
(10) Pub. No.: US 2018/0276727 A1
(43) Pub. Date: Sep. 27, 2018

(54) System and Method for Automated Retrieval of Apparel Items and the Like

(71) Applicant: Abzooba, Inc., Milpitas, CA (US)

(72) Inventors: Labhesh Patel, Santa Clara, CA (US); Pierre-Eric Melchy, San Jose, CA (US)

(21) Appl. No.: 15/666,819

(22) Filed: Aug. 2, 2017

Related U.S. Application Data
(63) Continuation-in-part of application No. 15/469,316, filed on Mar. 24, 2017.

(51) Int. Cl. G06Q 30/06

(52) U.S. Cl. CPC G06Q 30/0603; G06Q 50/01; G06Q 30/0631; G06Q 30/0625

(57) ABSTRACT

A computer-implemented method for automatically retrieving items for a user from an online product catalogue, the items being suitable for an upcoming calendar event, includes receiving, by a server, data from a curated list over a network, the data including curated classifications of apparel items. Trending apparel items are received by the server from selected websites for the upcoming calendar event. A deep learning module analyzes the data from the curated list and the trending apparel items to learn attributes associated with the upcoming calendar event. The server searches the online product catalogue for one or more selected apparel items which match the learned attributes. Information regarding the one or more selected apparel items is then returned to a client device of the user.

### RELATED APPLICATIONS

This is a continuation-in-part (CIP) application of application Ser. No. 15/469,316 filed Mar. 24, 2017, which application is assigned to the assignee of the present CIP application.

### TECHNICAL FIELD

The present disclosure relates generally to the field of cloud computing; more particularly, to computer vision systems and methods for automated processing, analyzing and understanding digital images on websites, mobile applications, and cloud-based applications.

### BACKGROUND

Electronic commerce, also known as eCommerce, continues to grow as more people purchase goods and services online over the Internet. Brands, website owners, and businesses engaged in e-commerce are understandably interested in optimizing the performance of their website in order to increase revenue. This has led to the development of a variety of tools including targeted advertising and dynamic content based on a person's previous purchases, behaviors, interests or demographics. Other tools provide business analytics that help a website owner improve the digital performance of their website in order to increase conversions. A conversion happens when a person who is browsing a website or application converts to being a user or buyer of a service or product that website or application offers. Conversions, understandably, are the lifeblood of an online business.

For many companies, every visitor to their website sees the same articles, offers and images, regardless of who they are or how they've interacted with that company in the past. Other companies attempt to deliver more personalized Web content which is allowed to evolve based on visitor interactions and activity. For example, a visitor's previous purchase or download may provide a starting point for a content management system that can pull in data from a marketing database, then display images and product offers based on the visitor's previous behaviors.

One of the problems faced by website designers and engineers is how to go about making intelligent product recommendations that are personalized to a visitor to an eCommerce site. Conventional approaches typically focus on demographics, previous search history and purchases when making recommendations for future purchases. For instance, if a visitor to a website previously purchased a shirt, the next time that person visits the same website, relevant dynamic content the retailer might display product recommendations for similar shirts, or items bought by persons who also bought that same shirt. When making product suggestions the difficulty is often in understanding the visitor's very personal likes and dislikes, many of which are not capable of being clearly articulated.

Another problem that arises in fashion, apparel and shoe retail is organizing product inventory to help the user navigate easily and quickly through the website. A common way to organize products is to create curated lists of items for specific upcoming occasions, events or seasons, such as, New Year's Eve, Valentine's Day, spring or autumn fashions, a formal dinner party, etc. These lists of items for given events or occasions are typically curated by one or several human curators. The curating process is labor intensive, slow and limited to large retailers that are able to afford a team of curators. In addition, curators are often biased towards the partial domain knowledge of the individuals curating the list. This can limit the ability of retailers to engage with current trends.

### BRIEF DESCRIPTION OF THE DRAWINGS

The present disclosure will be understood more fully from the detailed description that follows and from the accompanying drawings, which however, should not be taken to limit the invention to the specific embodiments shown, but are for explanation and understanding only.

FIG. 1 is an example high level architectural diagram of a system for making automated product recommendations that are personalized to a specific website visitor.

FIG. 2 is an example graphical user interface window that shows a product page of a retail website.

FIG. 3 is an example block diagram showing various components utilized for making personalized product recommendations for a website visitor.

FIG. 4 is an example flow diagram of a method for automated generation of one or more product recommendations for a website visitor.

FIG. 5 is an example block diagram that shows how learned features may be used to search an online product catalogue for relevant items.

FIG. 6 is an example flow diagram of a method for automated retrieval of fashion apparel and articles suitable for certain occasions or events.

FIG. 7 is an example flow diagram of a method for automated creation of custom articles based on user input.

### DETAILED DESCRIPTION

In the following description specific details are set forth, such as data analysis platforms, method steps, algorithms, devices, etc. in order to provide a thorough understanding of the subject matter disclosed herein. However, persons having ordinary skill in the relevant arts will appreciate that these specific details may not be needed to practice the present invention. It should also be understood that the elements in the FIGS. are representational.

References throughout this description to “one embodiment”, “an embodiment”, “one example” or “an example” means that a particular feature, structure or characteristic described in connection with the embodiment or example is included in at least one embodiment. The phrases “in one embodiment”, “in an embodiment”, “one example” or “an example” in various places throughout this description are not necessarily all referring to the same embodiment or example. Furthermore, the particular features, structures or characteristics may be combined in any suitable combinations and/or sub-combinations in one or more embodiments or examples.

In the context of the present application, the term “cloud” broadly refers to a collection of machine instances, storage and/or network devices that work together in concert. The term “cloud computing” refers to a paradigm in which machine storage, and application resources exist on a “cloud” of servers. In cloud computing shared resources, software and information are provided on-demand, like a public utility, via the Internet. Thus, cloud computing provides computation, data access, and storage resources without requiring users to know the location and other physical details of the computing infrastructure.

The term “server” broadly refers to any combination of hardware or software embodied in a computer designed to provide services to client devices or processes. A server therefore can refer to a computer that runs a server operating system from computer-executable code stored in a memory, and which is provided to the user as a virtualized or non-virtualized machine; it can also refer to any software or dedicated hardware capable of providing computing services. A web server is an information technology that processes requests via HTTP, the basic network protocol used to distribute information on the World Wide Web. A webpage is a web document that is suitable for the World Wide Web. A web browser running on a client or user computing device displays a web page on a monitor or mobile device screen.

In the context of the present, disclosure a “mobile computing device” “mobile device” (for short) refers to any one of a number of different portable electronic devices having a touch-sensitive display with a graphical user interface (GUI), one or more processors, memory and one or more modules, programs or sets of instructions for performing methods associated with the operations described herein. A mobile computing device typically runs on an operating system executed on one or more processors, and may also run one or more applications installed or resident in memory (e.g., firmware, RAM, EEPROM, etc.) In some embodiments, the mobile computing device may provide a plurality of functions including wireless communication, thereby allowing a user of the mobile device access data and information via connection to the Internet. Mobile computing devices include smartphones, tablet computers, wearable computers, ultra-mobile PCs, personal digital assistants, other hand-held devices, as well as other mobile computers (e.g., carputers) that have touch screen interfaces with wireless capabilities.

A “landing page” is any webpage on a website that serves as the initial point of entry for a user to the website. The landing page is typically the homepage, and is commonly accessible by clicking on a hyperlink on another web page, by clicking on a search engine search result, or by inputting a Hypertext Transfer (or Transport) Protocol (HTTP) address of a website to a browser application. Other types of common landing pages include category pages, which typically serve as product overview pages that link to an individual service, product or Stocking Keeping Unit (SKU) page and product pages, where you see SKU or service details, and where visitor can add an item to a shopping cart.

A “mouseover” or “mouse hover” is computer function in which one or more images or hyperlinks can be generated or activated when a user moves or “lovers” the cursor or pointer over a graphical hover area or trigger area of a web browser window (e.g., rollover window), usually with a mouse, but also possible using a digital pen or touch command. Mouseover events are not limited to web design and are commonly used in modern graphical user interface programming.

The term “real-time” refers to a level of computer responsiveness that a user senses as sufficiently immediate or that enables the computer to keep up with some external process (for example, to present visualizations of computed results). Thus, real-time is a mode of computer operation in which the computer collects data, analyzes or computes with the data, reports (e.g., visually displays) and/or stores the results nearly instantaneously, i.e., within a few seconds or less (milliseconds).

In the context of the present disclosure, a “widget” is an element of interaction in a graphical user interface (GUI), such as a button, icon, dialog box, pop-up window, pull-down menu, scroll bar, selection boxes, etc., that allows a user to interface with the application and operating system. The term widget also refers to the computer program that is written in order to make the graphic widget in the GUI look and perform in a specified manner, depending on what action the user takes while interfacing with the GUI. The term widget therefore may be used to refer to either the graphic component or its controlling program, or refer to the combination of both.

Computer vision an engineering field that deals with how computers can extract high-level information from digital images or videos, often with the goal of automating tasks that the human vision system can perform. These tasks typically include methods for acquiring, processing, analyzing and understanding digital images. Computer vision typically deals with extraction of high-dimensional data from the real world to produce information that may be in the forms of decisions. Deep learning is a branch of machine learning in which computers gain the ability to learn without being explicitly programmed based on a set of algorithms that attempt to model high level abstractions in data. Deep learning is part of a broader family of machine learning methods based on learning representations of data.

In one embodiment, a system, method and computer program product is provided for allowing an e-commerce website to utilize a widget that connects to one or more personalized social media feeds responsive to user input. The social media feeds may include blogs, photo-sharing application feeds such as Instagram feeds personal feeds of designers and/or celebrities, or other media feeds that include images or videos that reflect or represent a user's personal likes and preferences. In one example, the users personal likes and preferences pertain to the fields of fashion and style. In one embodiment the user is given the ability to sort through the images displayed in the feeds and select or designate images or videos that the person likes or finds appealing.

In one embodiment, responsive to a mouseover event when a user positions a cursor or pointer over a selected image on a product page of a retail website, a copy of that image is sent to a remote server. The remote server, upon receiving the image, segments the image into various constituent objects. For example, in the case where the user selects a particular product page image of a model wearing a number of items, the backend server segments the image into each of the detected constituent items or objects, e.g., shirt, pants, jacket, sun glasses, watch, shoes, etc. After segmentation and object detection, a software module or widget goes through the e-commerce site's product catalog and finds products that are visually similar to the detected segments or objects. That is, the program running on the remote server utilizes computer vision software to search through the retailer's product catalogue and select those items which most closely correspond to the detected segments/objects found in the user's selected image.

In another embodiment, instead of a mouseover event, a touch event may be utilized to trigger the sending of a copy of the image the user touches to a remote server. For example, a user of a mobile computing device that has a touch screen graphical user interface may touch a picture of image of a product when browsing a website or mobile app, which input, in turn, initiates the automated generation of one or more recommendations for products available on the website or mobile app.

In one embodiment, the software module, or a separate software module, may be used to rank the various product items according to a ranking criteria or algorithm, and then display them to the user as the user continues browsing the website or webpage. In one implementation the ranking criterion includes a similarity score between the objects detected in the image and objects present in the retailer's online product catalogue. In another embodiment, a ranking algorithm may include the popularity of the product being shown. In still another embodiment, the ranking may include the style preferences learned from the user's selected social media feeds.

In yet another embodiment, a system and method for automatically retrieving fashion and apparel items suitable for upcoming calendar events that a user might be interested in attending. Some such events can be weddings, casual work, formal work, parties, Valentine Day's, anniversaries, New Year's Eve, hiking, running, walking, cross-training, etc. The list of events presented here is by way of example, and is not to be considered exhaustive of the types of events for which the present disclosure is applicable.

In a specific embodiment, a method is provided which includes a training stage and an inference stage. In the training stage a software module searches online properties such as the open web, retailers' websites and catalogues for currently existing curated classifications, such as “dresses for New Year's eve”. The software module is configured to retrieve existing curated classifications provided by one or more retailers. Other publicly-available curated lists, such as on blogs or social media, may also be retrieved by the software module. In one embodiment, our software module crawls all such products and images belonging to a particular category and analyses them to find common attributes. In another embodiment, a deep learning module is used to analyze product images and the associated description, and automatically identify characteristic attributes. The deep learning module may be pre-trained, as well as fine-tuned for accuracy, utilizing currently existing labeled, public datasets.

In one embodiment all of the identified attributes are clustered together and input into another software module configured to learn which of the various attributes are associated with a certain search query. In another embodiment, the search query and attribute clusters can be saved in a knowledge database for use during the inference stage of the process. Preferably, the software module utilizes a multitude of different data sources to find curated lists for search queries. Utilizing a multitude of different data sources removes the bias that commonly results from a single curator.

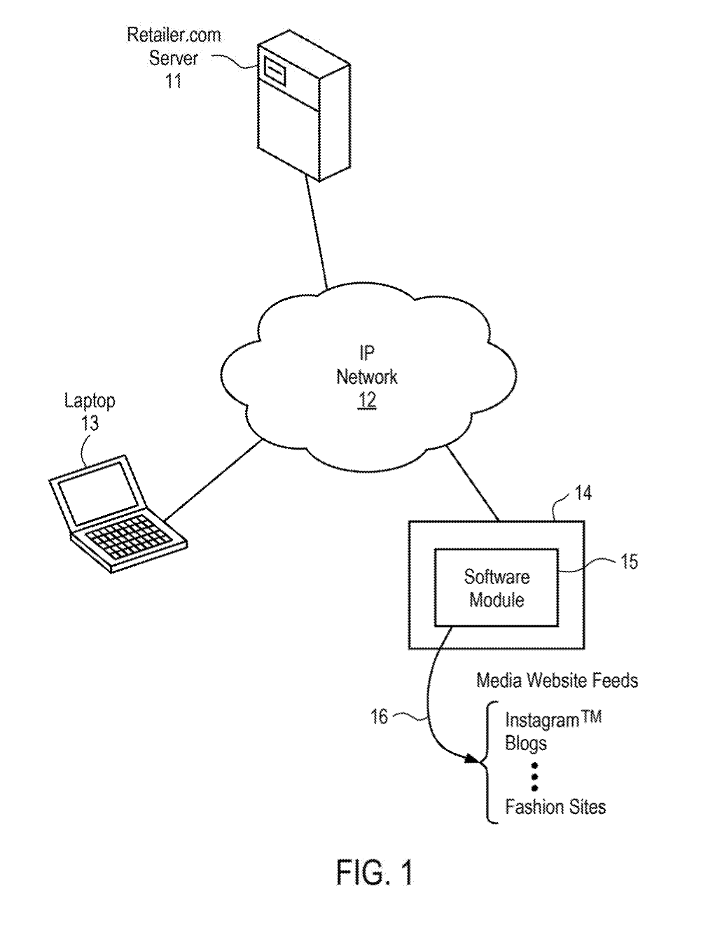

FIG. 1 is an example high-level architectural diagram of a system for making automated product recommendations that are personalized to a specific website visitor or user. As shown, the system includes a website server 11 associated with a retailer (Retailer.com) connected via a cloud 12 with a laptop computer 13 and a backend or remote server 14. Cloud 12 may comprise an Internet Protocol (IP) network, such as the general public Internet, or an intranet private computer network confined to an organization that uses IP technology or a combination of private and public networks. Laptop computer 13 may alternatively comprise one or more computing devices, including mobile devices, desktop computers, or any other computing device that is configured to accept user input, communicate with servers 11 and 14, navigate through the website or web application, and display images, text, results, etc. Similarly, server 11 shown in FIG. 1 may comprise a single server (as shown) or a plurality of servers, either located at a single center or distributed across different geographical locations.

In the embodiment shown, a product recommendation software module 15 resides on remote server 14. Software module 15 comprises a computer program that executes on server 14, with links 16 to one or more media sites or databases. In one embodiment, the user may personalize links 16: for instance, choosing which Instagram handles or blogs to follow, based on the user's personal tastes and preferences. When the user of laptop 13 positions the cursor over a product image on his display screen when browsing on the retailer's website, the mouseover event triggers the sending of the underlying image to software module 15. Deep learning models within software module 15 analyze the image.

Taking the image as input, and based on the user's, personal preferences as indicated by the user's preferences represented in their personalized links 16, the deep learning model searches the retailer's product catalogue to determine which items in the catalogue most closely match the user's preferences. In one embodiment, a list or set of images is generated which are visually similar to the selected or moused over image. The list may be automatically displayed to the user responsive to the mouseover event. In another embodiment, the list is stored and the user is alerted to the additional products selected by the deep learning model. For example, a message such as, “Click here to view other items you might like” may appear on the display screen of laptop 13, thereby allowing the user to view the automatically generated list of product selections at their leisure. Thus, the automated software module provides a customized or personalized shopping experience closely tailored to his or her likes and style preferences.

In another embodiment, the functionality provided by server 14 and software module 15 may be incorporated into retail server 11.

It is appreciated that in other embodiments, the computer program that executes in software module 15, or portions thereof, may be downloaded to execute on laptop 13. Links 16 to one or more media content websites may be accessed by server 11 and/or laptop 13. Server 11 communicates with laptop 13 via a browser application running on laptop 13.

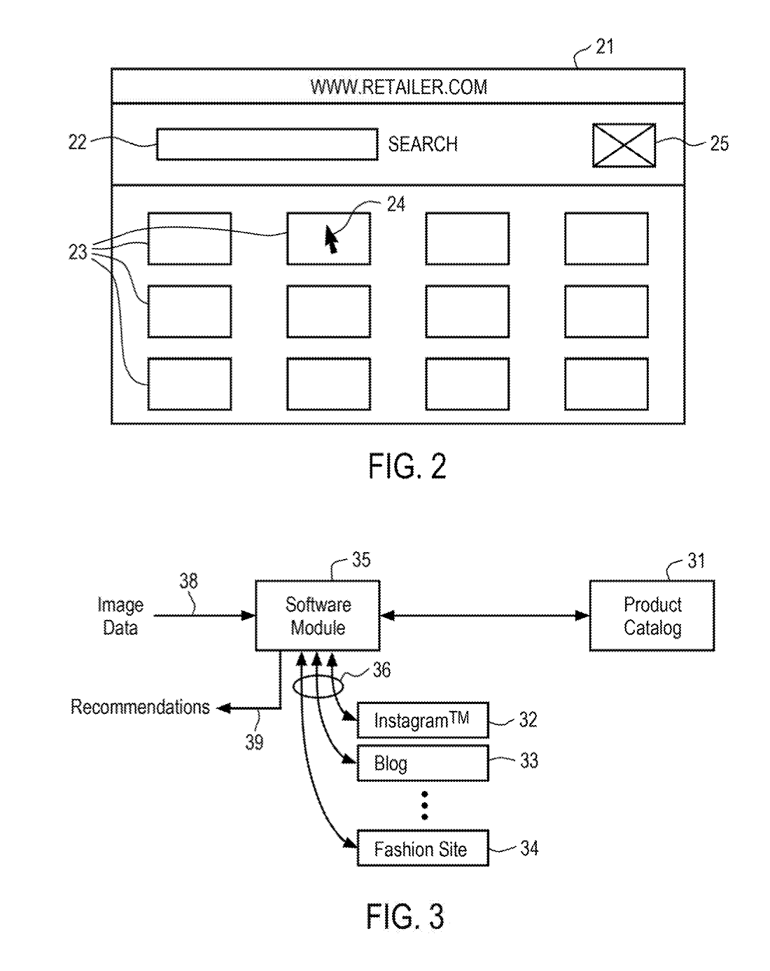

FIG. 2 is an example graphical user interface window 21 that shows a product page of a retail website. As shown, window 21 includes a search field 22 where a user may enter a product number, name, or keyword which results in a plurality of product image frames 23 being generated in a lower area of window 21 that correspond to the search input. For example, if the user entered “men's jacket” in search field 22, a plurality of images 23 may be generated of all the different jackets in the retailer's product catalogue. It is appreciated that there may be dozens or hundreds of items returned in response to the search phrase “men's jacket”.

In the example of FIG. 2 the user has positioned the cursor 24 over one of the jacket image frames 23 that the user is interested in. In one embodiment, this mouseover event triggers the deep learning model in the software module, represented by box 25, to analyze the image to find all of the various attributes of the jacket, e.g., texture, material, cut, color, style, brand, etc. In one embodiment the system asks the user to identify the specific attribute (e.g., color, style, texture, etc.) that is to be used to trigger the similarity search.

Using the links to the user's personalized media feeds, the software module may determine that the user finds inspiration in the clothes of a particular male celebrity, or blogs and specific fashion sites. Using the product image as initial input, and determining the user's preferences and styles of jackets via the user's personalized media links, the deep learning model is able to recommend items from the retailer's product catalogue which are similar to or match his preferences and styles. That is, the recommendations are based on the person's likes/interests as expressed via his links to various media sites, blogs, Instagram, fashion websites, etc. The software module assists the user in his product searches by making a connection between where the user finds fashion inspiration and which products on a particular retailer website most closely match his personal style preferences.

In one embodiment, software module 25 runs invisibly in the background to automatically display a set of similar or matching products responsive to a mouseover event. In another embodiment, an icon or trigger area is designated in window 21 for triggering software module 25 to perform an analysis and then display similar or matching items. For instance, the user may select or click on a particular product image and then mouseover or click on an icon or trigger area to perform the backend analysis and product recommendations.

In still another embodiment, the GUI running on the widget may be configured to allow the user to browse any website and drag-and-drop a selected product image to a sidebar area. In response, product recommendation results are automatically generated by the system and appear on an area of the browser screen (e.g., in the sidebar area). Thus, a single drag-and-drop step can initiate the analysis and product catalogue searching operations that generate customized product recommendations for the user. Persons of skill in the art will appreciate that this enables a user to search recommended product images without leaving the product page they are browsing. In one embodiment, this feature may be provided as a browser plugin.

The widget may also be configured to enable a user to see view customized product recommendations based on a video that the user is watching. For instance, an extension on the browser may send video frames to the backend sewer, which segments the images by attributes and returns similar product recommendation results. This can occur either in real-time and/or non-real-time. Real-time results may populate the display screen while the user is watching the video. Non-real-time results may be based on statistical analysis of one or more videos that the user has viewed within a specified time period. In one implementation, after the specified time period expires, a push notification may be sent to the user's computer device or to an application (e.g., email client, messaging app, pop-up window of the user's browser) that runs on the user's device.

In the event that the product image selected or moused over contains multiple items available for sale, e.g., jacket, pants belt, etc., software module 25 may generate multiple lists of product recommendations, one list for each item analyzed.

In one embodiment, the GUI allows a user to graphically “paint” a boundary around the object from the image that he or she is browsing. The software module then isolates the specific object and forks off a backend search as discussed above. In another embodiment, the user may paint a similar object across different images present in product image frame 23. The software module then isolates these specific objects and forks off a backend search using this set of objects as discussed above.

In another embodiment the e-commerce website software module captures and stores the various product image frames that a user clicks on and automatically creates a persona that is stored in a memory or database for the user based on the user's selections. The website may user the stored persona information to send personalized recommendations to the user. The recommendations may be generated in either real-time or non-real-time communication to the user. In one embodiment, the persona information created or the user may be used to personalize the user's image feed provided via the links to third party media content sites.

In another embodiment, the GUI allows a user to create an e-wardrobe on an e-commerce site by selecting various objects from different images. In yet another embodiment, the GUI allows an e-commerce website to use the e-wardrobe information of various users in making purchase and inventory decisions for their supply chain.

In still another embodiment, the GUI allows a user to provide voice command input. For instance, a user may provide voice input commands while viewing an image feed of product recommendations, or to indicate user likes and preferences. For example, during or after watching an image showing a particular item of a celebrity, a user might say, “I like the jacket”. The e-commerce endpoint (web or mobile) may use this speech input to rank the objects that are displayed to the user once the object segmentation and the backend visual search has produced candidate product recommendations.

In yet another embodiment, the computer program is configured to provide ensemble generation from an image provided by the user, that is, to make recommendations of products that are present in a selected or mouseover image. In addition, the software may be configured to make recommendations for products that are not in the image, but which relate to the product in the image, and which mach well with those articles based on the user preferences and styles reflected in the user's persona and/or links to media content feeds. By way of example, a user may hover over a pair of pants, which triggers additional pants product recommendations, but also triggers recommendations for other items, such as belts, shoes, shirts, etc., that compliment or go with the pants recommendations.

Voice and speech recognition software may also be incorporated in the software module to allow the user to comment on the product recommendations and refine or modify the product recommendations. For example, if the user mouses over an image of a bedside table, resulting in a set of additional table recommendations, the user may utilize voice commands to request a different color (“show tables that are tan in color”), shelving options (“show tables with magazine shelves”), or other features (“show tables with rounded edges”).

In one embodiment, rather than mousing over a particular product image and making product recommendations based on the information obtained through the user's customized links to various media sites, the user may generate a product recommendation for an item or ensemble through user input alone. That is, the user may provide input to the system, e.g., via voice commands or text, regarding what it is they would like to search for. In response, the product recommendation widget system creates a mock-up image of the desired item, which the user may refine further. Once the user is satisfied, the image can be sent to the remote server to generate an appropriate product recommendation. For example, the user may be looking for a bedside table tan in color, with a shelf to store magazines. In response to this input, the system creates a mock-up image of the desired item. The user may edit the image with further user interface input, e.g., the user could say, “Make the color a darker shade of tan”.

FIG. 3 is an example block diagram showing various components utilized for making personalized product recommendations for a website visitor. As shown, software module 35 is configured to receive image data 38 sent from a GUI running on the user's browser. In one embodiment, the sending of the image data may be triggered by a single mouseover event, where the user positions the cursor over a product image the user is viewing on a particular website or web application.

In response to receiving the image data, software module analyzes the image and then determines the user's style preferences for the item(s) or objects present in the image data via links 36 connected to various media content site feeds. By way of example, FIG. 3, shows feeds to Instagram 32, blog 33, and fashion site 34. Using the information obtained through links 36 to the user's customized feeds, software module searches the website's product catalogue 31 for items that most closely match the user's style preferences. The similar or closely matched items are then returned as product recommendations. In one embodiment, images of the recommended products are displayed on the display screen of the user's client device (e.g., laptop, mobile device, smart hone, tablet, etc.).

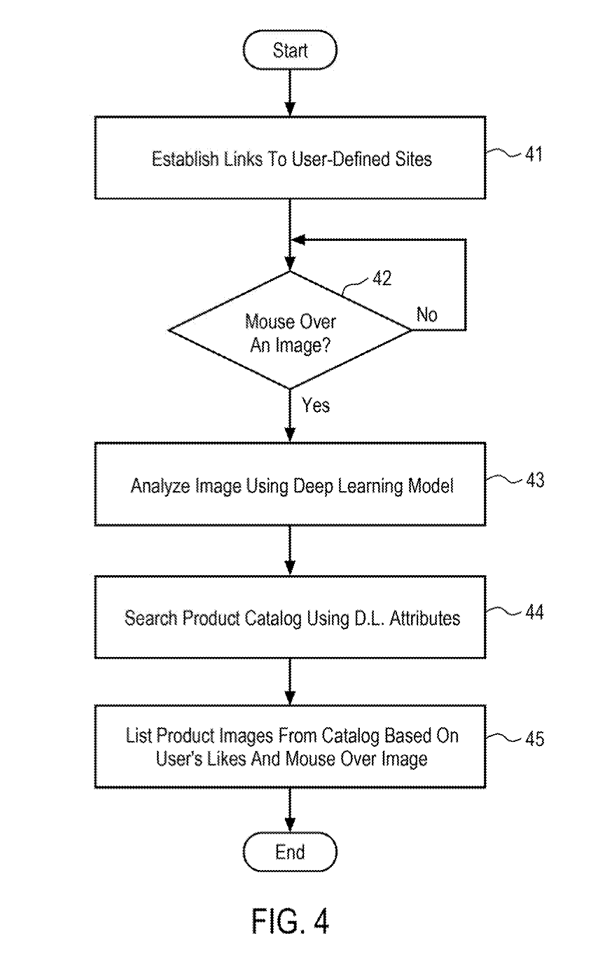

FIG. 4 is an example flow diagram of a method for automated generation of one or more product recommendations for a website visitor. The first step in the process is the establishment, by the widget, of one or more links to the user-defined sites that contain data/information regarding the user's likes, dislikes, and various style preferences. (Block 41) Note that this information may be in the form of images that the user has indicated he or she likes and/or dislikes. A query is performed next to determine whether the user has moused over an image on a product page of the website that he or s he is navigating through. (Block 42) If a mouseover event has occurred, a digital image of the selected item is automatically sent to a backend server (or the website server) where it is analyzed by a software module that includes a deep learning model. (Block 43)

It is appreciated that other types of user input, may also be used in the determination that triggers the sending of the image to the software module. In another embodiment, the step that establishes the links to the user-defined sites may occur responsive to the mouseover event, not before. In another embodiment, instead of a mouseover event, a mock-up image may be created through user input that describes the product item the user is seeking, the input included details of various features the user desires.

The analysis of the received image utilizes a deep learning model to first segment the image into its constituent objects, attributes and feature e.g., a long sleeve, buttoned, collared dress shirt. Based on the data feed links established previously which may provide specific examples, of long sleeve, buttoned, collared shirts that the user likes or which express their style/design/fashion preferences, the deep learning model searches the product catalogue of the website that the user is browsing for shirts that closely match the user's preferences. (Block 44) The resulting list of items in the product catalogue that are similar or most closely match the user's preferences is returned to the user's client device. (Block 45) In one embodiment, the list appears in a browser window on the display screen of the client device in the form of a set of product images taken from the catalogue.

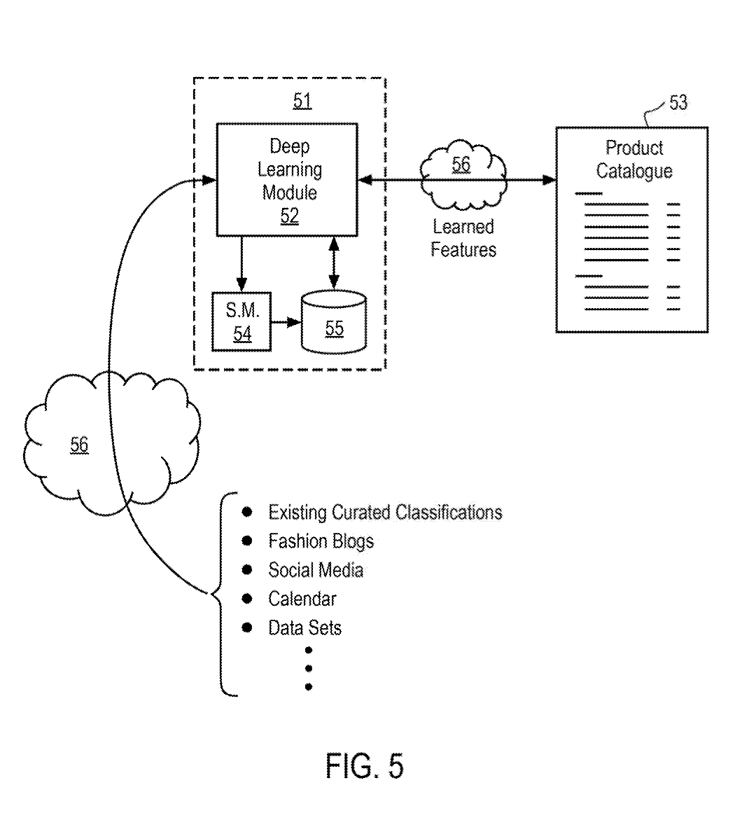

FIG. 5 is an example block diagram of a system that shows how learned features may be used to search an online product catalogue for relevant items. As shown, the system includes a server 51 having a deep learning software/hardware module 52 connected to a cloud 56. Cloud 56 may comprise an Internet Protocol (IP) network, such as the general public Internet, or an intranet private computer network confined to an organization that uses IP technology or a combination of private and public networks.

During learning or training, deep learning module 52 may search retailers' websites and online catalogues (via cloud 56) for currently existing curator classifications. These classifications may include fashions and apparel for certain calendared events or occasions such as New Year's Eve, Valentine's Day, etc. These may be general holidays, but also may include events and occasions personalized to each specific user, e.g., an anniversary, birthday, or planned outing or excursion (e.g., a Caribbean vacation). In one embodiment, deep learning module 52 is configured to retrieve existing curated classifications provided by one or more online retailers. Other publicly-available curated lists, such as on fashion blogs or social media, may also be retrieved by module 52. For example, fashion blogs typically feature items that are trending or in vogue for an upcoming season, holiday, event, or other calendared occasions. The links to websites, social media, blogs, and datasets may be selectable according to the user's viewing or browsing history, or generalized according to the upcoming event or occasion coming up on a calendar application.

In one embodiment, deep learning module 52 receives images and descriptions of product items belonging to a particular classification category, and then analyzes them to automatically find/identify characteristic attributes. For instance, module 52 may learn that the fashion trend in dresses for the upcoming Valentine's Day are silk red dresses with a plunging neckline and slightly above-knee length. The deep learning module may be pre-trained, as well as fine-tuned for accuracy, utilizing currently existing labeled, public datasets.

In another embodiment, all such attributes are clustered together and input into another software module 54 that learns the various attributes associated with a certain search query. In another embodiment, these search query and attribute clusters can be stored in a knowledge database 55 to be further used during a subsequent inference stage or steps. Knowledge database 55 may be incorporated into memory/disc storage of server 51, or comprise a separate storage device.

Persons of skill in the art will appreciate that modules 52 and 54 of server 51 may utilize a multitude of different data sources for finding curated lists for such search queries. These sources may include existing curated lists, fashion blogs/websites, social media, and publically-available datasets. Server 51 may also be configured to access calendar applications to determine upcoming events, both public (e.g., national holidays, special occasions, etc.) and private events and occasions (e.g., a child's graduation, anniversary, etc.) customized for a particular user. It is further appreciated that the process of clustering attributes across these various data sources eliminates the bias inherent in the use of a single curator.

In an inference stage of operation, deep learning module 52 processes users' queries. For example, a user may audibly or textual input a query such as, “I want a dress for New Year's Eve”. In one embodiment, queries may be collected via a chat of that interfaces between users and our software. A chatbot (also known as a talkbot, chatterbot, Bot, or chatterbox) is a computer program which conducts a conversation via auditory or textual methods. In another embodiment, queries may be collected in the search box of a user interface available on web browsers. A collected query may then input into the previously-trained deep learning module 52 to retrieve relevant product attributes/features as identified in the training stage. These attributes/learned features are used to retrieve relevant products (e.g., apparel items) from an online product catalogue 53. That is, the system searches product catalogue 53 for items that match the closest features/attributes previously learned. The product descriptions and images of the most relevant items found in product catalogue 53 are then returned to the user's client device for display thereon.

In one embodiment, the items returned from the search results may be ranked in order of how closely each item matches the learned attributes. For instance, if a user input a query “dress” on February 10^{th}, the system might assign red dresses with a higher ranking, since Valentine's Day is less than a week away.

In one embodiment, the retrieval process is based on the lookup of knowledge base 55 built during training stage. In another embodiment, semantic understanding is enabled by the use of word vectors; that is, the query is transformed into a word embedding. The representation resulting from this semantic understanding process is then input into a pre-trained module to retrieve relevant items.

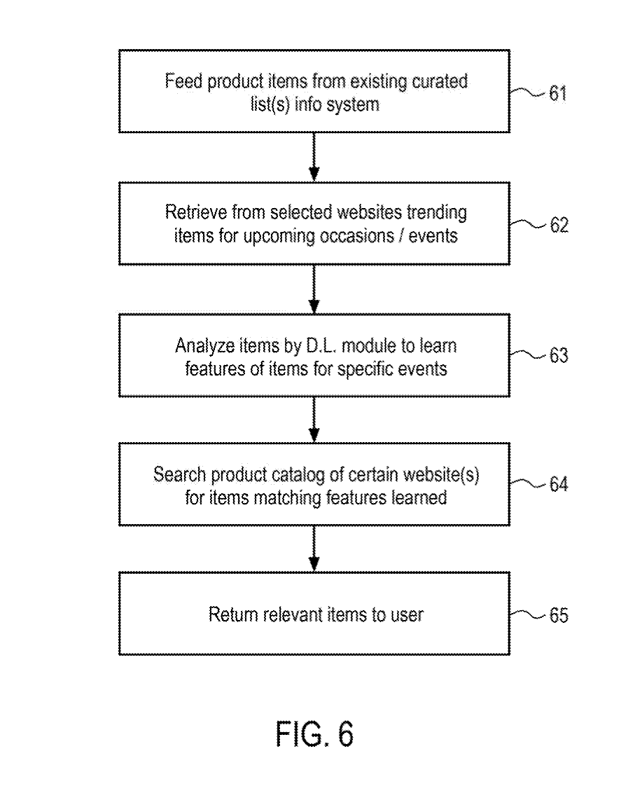

FIG. 6 is aid example flow diagram of a method for automated retrieval of fashion apparel and articles suitable for certain occasions or events. The process begins with the feeding into the system product items from existing curated lists found on various websites accessible via the Internet. (Block 61) Trending items may also be retrieved from selected websites for upcoming occasions and events. (Block 62) For example, the websites may include curated shopping sites that offer product recommendations by expert stylists and celebrities. Other websites may provide community-curated products or curated lists of apparel items from preferred designers, brands and boutiques.

Next, the curated lists and trending items retrieved are analyzed by a deep learning module to learn the attributes/features for specific events and occasions. (Block 63) In response to a user query, a search is performed in an online retailer's product catalogue for relevant apparel items that closely match the attributes/features learned during the training phase described above. (Block 64) The relevant items found during searching are returned to the user. (Block 65) In one embodiment, images and a description of the relevant items are displayed on a browser running on the user's client device.

In another embodiment, when an apparel item is returned in a search result, or as a result of an automated recommendation, the user may make a further query to modify the product item in some way. For example, a user may input a query such as, “I need a green dress for under $150”; in response, and the automated system performs a search that returns a recommended dress that displayed for the user. At this point the user may request that the item displayed be modified or customized in some manner. By way of example, the person may input, via text or speech, “I want a tinge of yellow on this dress” In response, the system may perform another search for items that satisfy the user's request for a green dress with a tinge of yellow. In one embodiment, the system creates a mock-up graphical image of the green dress, but with a tinge of yellow. Further modifications and refinements to the graphical image may be made responsive to further user input. When the user is satisfied, he or she may click on an “Order” button on a graphical user interface. In response, the system may send the final image of the dress, a description of the article, and the users stored measurements, to a third party website or manufacturer of custom clothing of the user's choice. In other words, in one embodiment the system may configured to initiate an order to make custom clothing items or other articles based on the user's own designs and preferences.

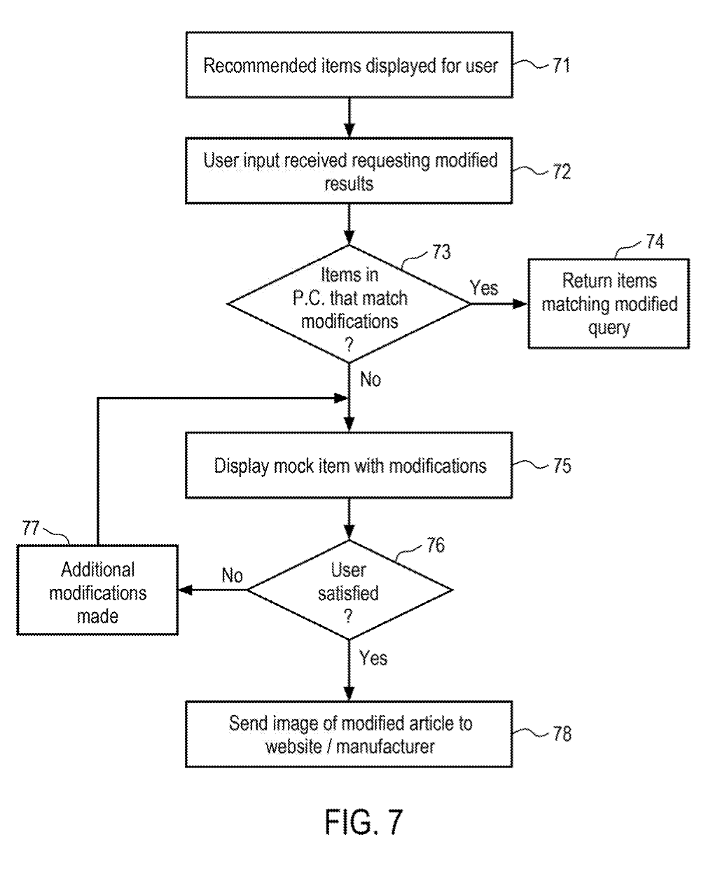

FIG. 7 is an example flow diagram of a method for automated creation of custom articles based on user input. The process begins with the system returning one or more recommended items for display on the user's client device display screen. (Block 71) At that point, the user may request that the item or article be modified in some way. (Block 72) The user input may be audible, text, touch-based, or via any other user interface appropriate for modifying an image. At decision block 73 the system performs a search in the product catalogue to determine whether an item already exists that closely matches the modified product image. If there are one or more items that match the user's modified query, those items are returned to the user's display screen. (Block 74)

In the event that no matching items exist in the product catalogue the system graphically generates a mock item with the requested modification for display to the user. (Block 75) At decision block 76, the user is queried to see if he or she is satisfied with the product image generated. If the user is not satisfied, the user is given the opportunity to make further modifications. (Block 77) When the user is finally satisfied, an image of the item may be sent to a website/manufacturer that use the image and description to create a customized article for the user. (Block 78)

It should be understood that elements of the disclosed subject matter may also be provided as a computer program product which may include a machine-readable medium having stored thereon instructions which may be used to program a computer (e.g., a processor or other electronic device) to perform a sequence of operations, such as those described above. Alternatively, the operations may be performed by a combination of hardware, firmware, and software. The machine-readable medium may include, but is not limited to, floppy diskettes, optical disks, CD-ROMs, and magneto-optical disks, ROMs, RAMs EPROMs, EEPROMs, magnet or optical cards, or other type of machine-readable medium suitable for storing electronic instructions.

Additionally, although the disclosed subject matter has been described in conjunction with specific embodiments, numerous modifications and alterations are well within the scope of the present invention For instance, although examples have been described for use in making customized product recommendations for a user navigating to a website, the disclosed widget also applies to mobile apps, chat bots, and other types of delivery mechanisms. Accordingly, the specification and drawings are to be regarded in an illustrative rather than a restrictive sense.

We claim:

1. A computer-implemented method for automatically retrieving items for a user from an online product catalogue, the items being suitable for an upcoming calendar event, the computer-implemented method comprising:
receiving, by a server, data from a curated list over a network, the data including curated classifications of apparel items;
receiving, by the server, trending apparel items from selected websites for the upcoming calendar event;
analyzing, by a deep learning module that executes on the server, the data from the curated list and the trending apparel items to learn attributes associated with the upcoming calendar event;
searching, by the server, the online product catalogue for one or more selected apparel items which match the learned attributes; and
returning, by the server, information regarding the one or more selected apparel items to a client device of the user.

2. The computer-implemented method of claim 1 wherein the information includes one or more images of each of the one or more selected apparel items.

3. The computer-implemented method of claim 2 wherein the information further includes a description of each of the one or more selected apparel items.

4. The computer-implemented method of claim 1 wherein the searching is performed responsive to a query of the user.

5. The computer-implemented method of claim 1 wherein the query comprises a natural language voice command.

6. The computer-implemented method of claim 1 further comprising storing in a knowledge database various ones of the attributes associated with a specific search query.

7. The computer-implemented method of claim 1 wherein the selected websites include at least one or more of fashion blog websites, social media websites, and publically-available datasets.

8. The computer-implemented method of claim 1, further comprising ranking the one or more selected apparel items according to a ranking criteria.

9. The computer-implemented method of claim 8 wherein the ranking criteria is how closely each of the one or more selected apparel items matches the learned attributes.

10. The computer-implemented method of claim 1 wherein the server comprises a remote server of a third party service.

11. A non-transitory computer-readable storage medium encoded with computer instructions, which, when executed by one or more processors, is operable to:
receive, by a server, data from a curated list over a network, the data including curated classifications of apparel items;
receive, by the server, trending apparel items from selected websites for the upcoming calendar event;
analyze, by a deep learning module that executes on the server, the data from the curated list and the trending apparel items to learn attributes associated with the upcoming calendar event;
search, by the server, the online product catalogue for one or more selected apparel items which match the learned attributes; and
return, by the server, information regarding the one r more selected apparel items to a client device of the user.

12. The non-transitory computer-readable storage medium of claim 11 wherein the information includes one or more images of each of the one or more selected apparel items.

13. The non-transitory computer-readable storage medium of claim 11 wherein execution of the computer instructions is further operable to store in a knowledge database various ones of the attributes associated with a specific search query.

14. The non-transitory computer-readable storage medium of claim 12 wherein the information further includes a description of each of the one or more selected apparel items.

15. The non-transitory computer-readable storage medium of claim 11 wherein the search is performed responsive to a query of the user.

16. The non-transitory computer-readable storage medium of claim 11 wherein execution of the computer instructions is further operable to rank the one or more selected apparel items according to a ranking criteria.

17. The non-transitory computer-readable storage medium of claim 15 wherein the query comprises a natural language voice command.

18. The non-transitory computer-readable storage medium of claim 16 wherein the ranking criteria is how closely each of the one or more selected apparel items matches the learned attributes.
